(19) United States
(12) Patent Application Publication
(10) Pub. No.: US 2025/0087046 A1
(43) Pub. Date: Mar. 13, 2025

(54) HOLD AND SPIN WITH OVERLAPPING FEATURES AND EXPANDING REELS GAMING SYSTEMS AND METHODS

(71) Applicant: Aristocrat Technologies, Inc., Las Vegas, NV (US)

(72) Inventors: Eric Boese, Decatur, GA (US); Jae Yi, Alpharetta, GA (US); Ronald Williams, II, Atlanta, GA (US)

(21) Appl. No.: 18/808,741

(22) Filed: Aug. 19, 2024

Related U.S. Application Data
(60) Provisional application No. 63/581,760, filed on Sep. 11, 2023.

(51) Int. Cl. G07F 17/32; G07F 17/34

(52) U.S. Cl. CPC G07F 17/3213; G07F 17/34

(57) ABSTRACT

An electronic gaming system including a memory and processor is described. The processor is configured to cause display of a plurality of game symbols in a plurality of symbol positions within an active play area and an inactive play area of a base game wherein the inactive play area includes stacks of symbol positions each stack corresponding to a column of a first subset of columns in the active play area; cause a bonus game to be triggered when a number of designated symbols are displayed within the active play area and displayed in the inactive play area in a symbol position adjacent to an upper row of the active play area; and as part of the bonus game, cause the active play area to expand upwardly to include a portion of the inactive play area to a height equal to a highest symbol position displaying contiguous designated symbols.

### CROSS REFERENCE TO RELATED APPLICATIONS

This application claims the benefit of priority to U.S. Provisional Patent Application No. 63/581,760, filed Sep. 11, 2023, which is hereby incorporated by reference herein in its entirety.

### TECHNICAL FIELD

The field of disclosure relates generally to electronic gaming machines, and more specifically, to systems and methods of triggering a hold and spin game with overlapping features and expanding reels during a bonus game.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system including at least one memory with instructions stored thereon, and at least one processor in communication with the at least one memory is provided. When executed by the at least one processor, the instruction cause the at least one processor to (i) cause display of a plurality of game symbols in a plurality of symbol positions within an active play area and an inactive play area of a base game, the active play area including a plurality of rows and columns of symbol positions, and the inactive play area including a plurality of stacks of symbol positions, each stack of the plurality of stacks corresponding to at least one column of a first subset of columns of the plurality of columns, (ii) cause a bonus game to be triggered when a predetermined number of designated symbols are displayed within the active play area and at least one of the designated symbols is displayed in the inactive play area in a symbol position adjacent to an upper row of the active play area; and (iii) as part of the bonus game, cause the active play area to expand upwardly to include at least a portion of the inactive play area to a height equal to a highest symbol position displaying contiguous designated symbols.

In another aspect, a computer-implemented method of electronic gaming implemented by at least one processor in communication with at least one memory is provided. The method includes (i) causing display of a plurality of game symbols in a plurality of symbol positions within an active play area and an inactive play area of a base game, the active play area including a plurality of rows and columns of symbol positions, and the inactive play area including a plurality of stacks of symbol positions, each stack of the plurality of stacks corresponding to at least one column of a first subset of columns of the plurality of columns; (ii) causing a bonus game to be triggered when a predetermined number of designated symbols are displayed within the active play area and at least one of the designated symbols is displayed in the inactive play area in a symbol position adjacent to an upper row of the active play area; and (iii) as part of the bonus game, causing the active play area to expand upwardly to include at least a portion of the inactive play area to a height equal to a highest symbol position displaying contiguous designated symbols.

In another aspect, at least one non-transitory computer-readable storage medium with instructions stored thereon is provided. In response to execution by at least one processor, the instructions cause the at least one processor to (i) cause display of a plurality of game symbols in a plurality of symbol positions within an active play area and an inactive play area of a base game, the active play area including a plurality of rows and columns of symbol positions, and the inactive play area including a plurality of stacks of symbol positions, each stack of the plurality of stacks corresponding to at least one column of a first subset of columns of the plurality of columns; (ii) cause a bonus game to be triggered when a predetermined number of designated symbols are displayed within the active play area and at least one of the designated symbols is displayed in the inactive play area in a symbol position adjacent to an upper row of the active play area; and (iii) as part of the bonus game, cause the active play area to expand upwardly to include at least a portion of the inactive play area to a height equal to a highest symbol position displaying contiguous designated symbols.

In another aspect, an electronic gaming machine (EGM) including an interface component coupling the EGM with an electronic gaming service, a memory device storing instructions, and a game controller including a processor is disclosed. The processor is configured to execute the instructions stored in the memory device, which, when executed by the processor, cause the game controller to: (i) during a base game play, cause display of a plurality of game symbols in a plurality of symbol positions in an active play area and an inactive play area, where the active play area includes a plurality of rows and columns of symbol positions, the inactive play area includes a plurality of stacks of symbol positions, and each stack of the plurality of stacks corresponds to at least one column of a first subset of columns of the plurality of columns; (ii) cause a bonus game to be triggered when a predetermined number of designated symbols are displayed within the active play area and at least one of the designated symbols is displayed in the inactive play area in a symbol position adjacent to an upper row of the active play area; and/or (iii) as part of the bonus game, cause the active play area to expand upwardly to include at least a portion of the inactive play area, in which the active play area is expanded upwardly to a height equal to a highest symbol position displaying designated symbols that are contiguous with the upper row of the active play area.

In another aspect, a computer-implemented method is disclosed. The method includes, during a base game play, causing display of a plurality of game symbols in a plurality of symbol positions in an active play area and an inactive play area. The active area includes a plurality of rows and columns of symbol positions, and the inactive play area includes a plurality of stacks of symbol positions. Each stack of the plurality of stacks corresponds with at least one column of a first subset of columns of the plurality of columns. The method includes causing a bonus game to be triggered when a predetermined number of designated symbols are displayed within the active play area and at least one of the designated symbols is displayed in the inactive play area in a symbol position adjacent to an upper row of the active play area, and, as part of the bonus game, expanding the active play area upwardly to include at least a portion of the inactive play area. The active play area is expanded upwardly to a height equal to a highest symbol position displaying designated symbols that are contiguous with the upper row of the active play area.

In yet another aspect, an electronic gaming application server that is communicatively coupled with an electronic gaming machine (EGM) is disclosed. The electronic gaming application server includes a memory device storing instructions, at least one random number generator (RNG), and a game controller including a processor that is configured to execute the instructions stored in the memory device. The processor causes the game controller to, during a base game play, cause display of a plurality of game symbols in a plurality of symbol positions in an active play area and an inactive play area. The active area includes a plurality of rows and columns of symbol positions, and the inactive play area includes a plurality of stacks of symbol positions. Each stack of the plurality of stacks corresponds with at least one column of a first subset of columns of the plurality of columns. The processor causes the game controller to cause a bonus game to be triggered when a predetermined number of designated symbols are displayed within the active play area and at least one of the designated symbols is displayed in the inactive play area in a symbol position adjacent to an upper row of the active play area, and, as part of the bonus game, expand the active play area upwardly to include at least a portion of the inactive play area. The active play area is expanded upwardly to a height equal to a highest symbol position displaying designated symbols that are contiguous with the upper row of the active play area.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4A-4C each illustrates an exemplary screenshot or user interface of an electronic gaming machine (EGM) during a base game play, in accordance with certain embodiments of the present disclosure.

FIG. 5 illustrates an exemplary screenshot or user interface of an EGM when a bonus game is triggered, in accordance with certain embodiments of the present disclosure.

FIG. 6 illustrates an exemplary screenshot or user interface of an EGM, in accordance with certain embodiments of the present disclosure, showing a triggering of additional features.

FIG. 7 illustrates an exemplary screenshot or user interface of an EGM, in accordance with certain embodiments of the present disclosure, showing a triggering of additional features.

FIG. 8 illustrates an exemplary flow-chart of method operations performed by an EGM, in accordance with certain embodiments of the present disclosure.

### DETAILED DESCRIPTION

Generally, in electronic gaming machines (EGMs), a bonus or feature game may be triggered when a certain number of designated symbols and/or a specific symbol or symbols land on reels during play of a base game. During the bonus game, the player may be awarded an additional round of game play, one or more free spins, a different set of symbols, prizes, and/or multipliers. While the player may get an additional opportunity to earn more prizes during a conventional bonus game, the bonus game described herein includes expanding reels that, when the bonus game is triggered, expand the active game play area into an inactive area up to a height matching the maximum height of continuous or contiguous symbols that extend from the active play area into the inactive area thereby activating the inactive area up to that matching height. In addition, the bonus game described herein includes opportunities to win additional prizes and/or rewards by assigning one or more categories or additional features to one or more of the expanding reels such that when the reels expand the reel that triggers the expansion also triggers the additional feature corresponding to that triggering reel and that additional feature is applied to the bonus game.

The one or more additional features or categories in which a player may win additional prizes and/or rewards may depend on the column or stack of the base game on which a specific symbol lands during the base game. By way of a non-limiting example, a base game matrix may include a specific number of reels or columns (e.g., 5 columns), and each column may include symbol positions for displaying a particular number of game symbols (e.g., 3 game symbols). In other words, the base game matrix (or active play area) may be an m×n matrix, where m represents a number of game symbols displayed or rows on each column, and n represents a number of columns of the base game matrix.

Each column of the n number of columns of the base game matrix may be associated with a respective stack extending above the base game matrix. In other words, the stacks may define the inactive play area during the base game which may be converted into an additional active play area during the bonus game. Accordingly, there may be n number of stacks extending above the columns of the base game active play area. Out of the n number of stacks, one or more stacks may be assigned an additional feature or specific category of a prize to be awarded during the bonus game. By way of a non-limiting example, the one or more stacks may be randomly identified, or selected, and/or the specific category of the prize may be randomly assigned to the identified, or selected, one or more stacks. A specific feature assigned to a stack may include, but is not limited to, a boost feature, a win-all feature, an extra-coin feature, and so on.

In the example embodiment, the base game matrix (or initial active play area) may be displayed in a bottom section of a display device of an electronic gaming machine (EGM), while the one or more stacks assigned a specific category or additional feature may be displayed above certain columns of the base game matrix and shown in an inactive play area of the display device of the EGM. In the example embodiment, during the base game play, game symbols may be displayed as rolling from the top of the one or more stacks as the reels are spinning. However, while the reels are spinning, only cash on reels (COR) game symbols are displayed as falling through the inactive play area in the upper section of the display device of the EGM and any non-COR symbols may be hidden or invisible while falling through the inactive play area in the upper section of the display device of the EGM. The non-COR symbols may then be displayed only when the non-COR symbols are in the lower section (the active play area of the base game) of the display device of the EGM associated with the base game matrix.

In some examples, when the reels stop spinning during a base game play, if a certain number of designated symbols (e.g., 6 COR symbols) are displayed on the reels of the active base game play area, a bonus game play may be triggered. In addition, if at least one designated symbol (COR symbol) is displayed within the inactive area on one of the stacks and is contiguous with the top symbol displayed in the base game area (e.g., no gaps in the symbols extending upwardly from the base game area to the symbols in the stack), then the expanding reel feature is triggered and the active play area of the base game matrix expands upwardly to the maximum height of the contiguous COR symbols within the stacks. In addition, the additional feature or specific category of prize assigned to the highest stack of contiguous COR symbols is triggered for the bonus game.

During the bonus game, the base game matrix may be expanded as described above to m₁×n₁, where my may represent a number of rows of symbol display positions on each column during the bonus game play, and n₁ may represent a number of columns during the bonus game play.

In the example embodiment, and by way of a non-limiting example, n₁ may be same as n, which corresponds with the number of columns during the base game play. And m₁ may be greater than m, which corresponds with a number of rows of symbol positions in each column during the base game play, and this is a result of the expanding number of reels or play area. In the example embodiment, the value of m₁ may be determined based on a highest position of a contiguous COR symbol in the upper section (inactive play area) of the display device of the EGM within a stack that is assigned the specific category of prize, which caused the triggering of the bonus game. During the bonus game, the player may be awarded the prize of the specific category associated with the stack that triggered the bonus game because of the COR symbol landing on the reel.

In some examples, the bonus game may be triggered by COR symbols landing on more than one stack above the base game columns, and the value of m₁ (number of rows) may be determined based on the maximum height of contiguous COR symbols that are displayed within a stack associated with an assigned specific category of prize. During the bonus game, the player may be awarded the prize of the specific category, or an additional feature or feature enhancement associated with the column displaying the COR symbol at the highest contiguous position when the reels are stopped, and the bonus game is triggered. Alternatively, the player may be awarded the prize of the specific category associated with each reel that contributed to triggering the bonus game.

Accordingly, by dynamically extending a game matrix when a bonus game is triggered, while displaying COR symbols on the top section of the display device while reels are spinning during a base game play, may create a higher anticipation and intuitiveness in a player regarding an expansion of the game matrix and which one or more bonus features may be triggered for the bonus game.

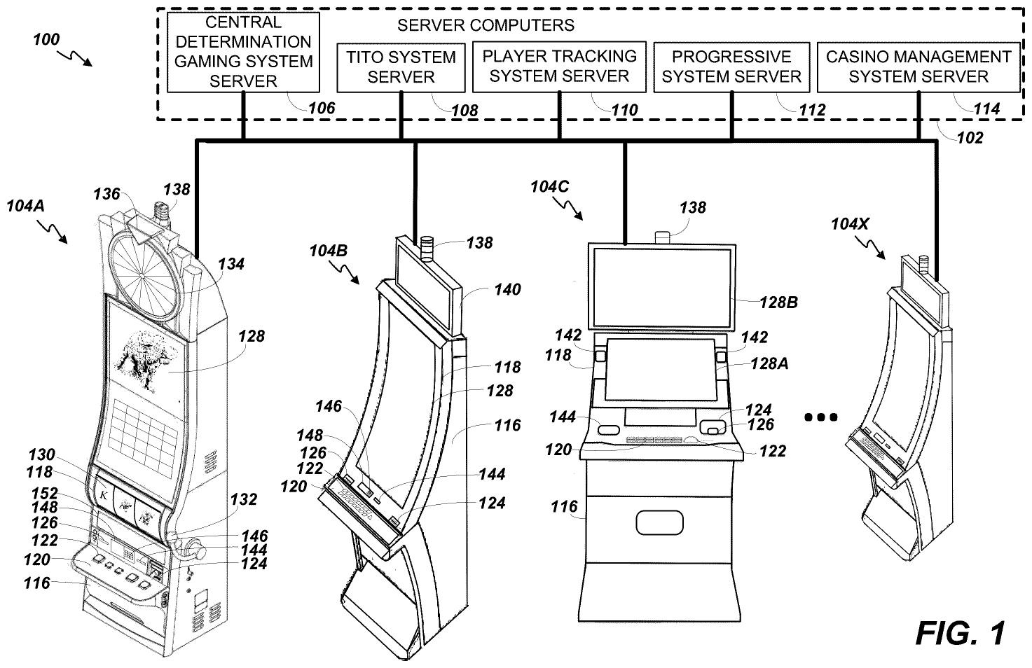

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

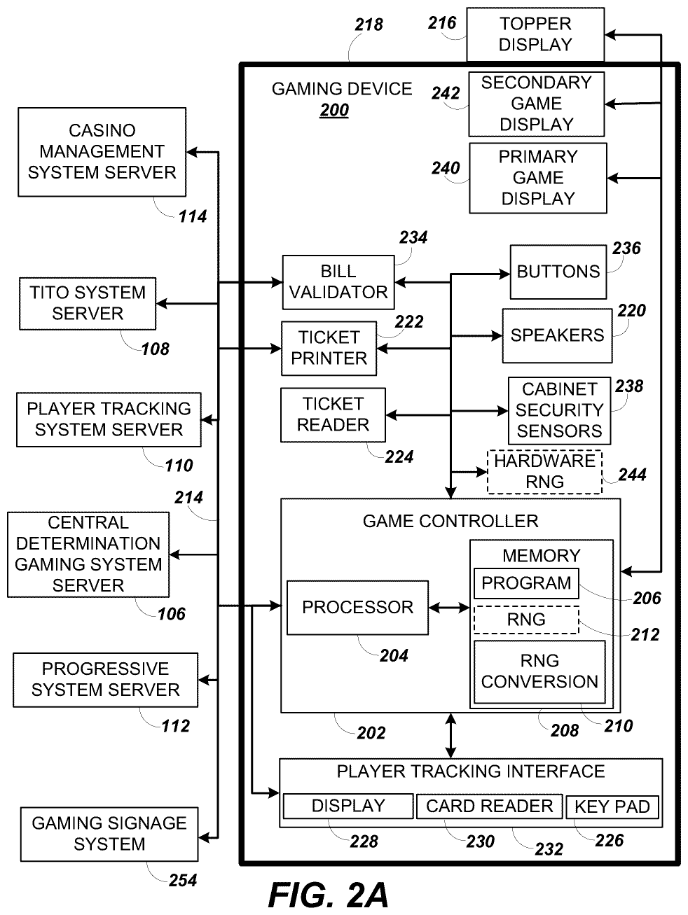

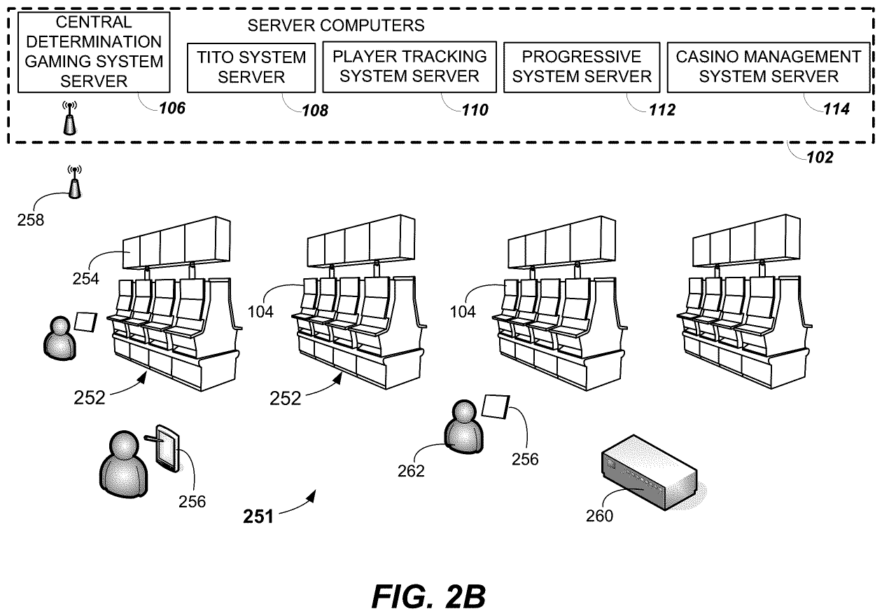

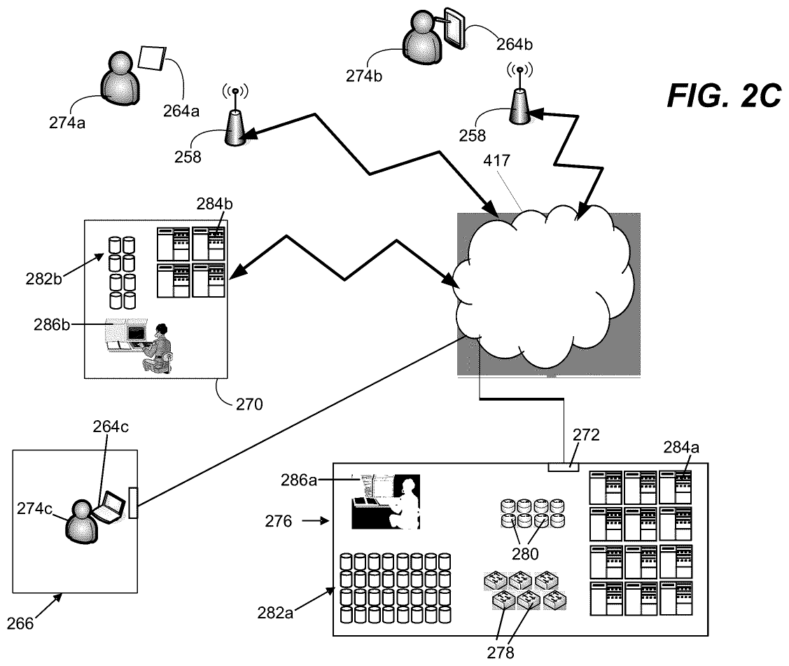

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. In general, volatility refers to the frequency or probability of an event such as a special mode, a payout, etc. For example, for a target level of RTP, a higher-volatility game may have a lower payout most of the time with an occasional bonus having a very high payout, while a lower-volatility game has a steadier payout with more frequent bonuses of smaller amounts. Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

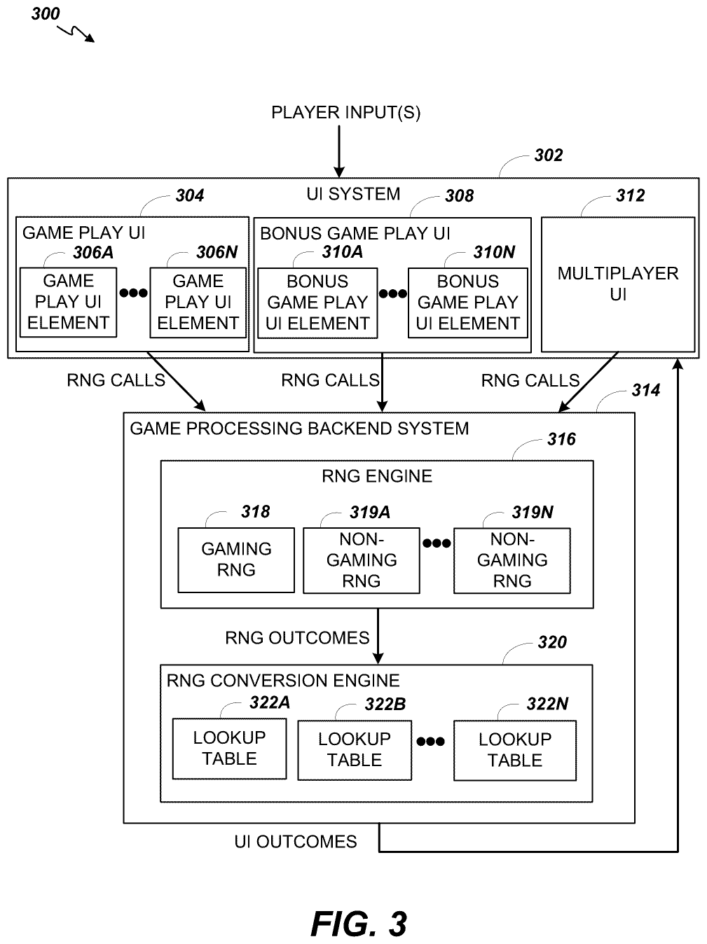

FIG. 3 illustrates, in block diagram form, an implementation of a game processing architecture 300 that implements a game processing pipeline for the play of a game in accordance with various implementations described herein. As shown in FIG. 3, the gaming processing pipeline starts with a UI system 302 receiving one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, or additionally, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

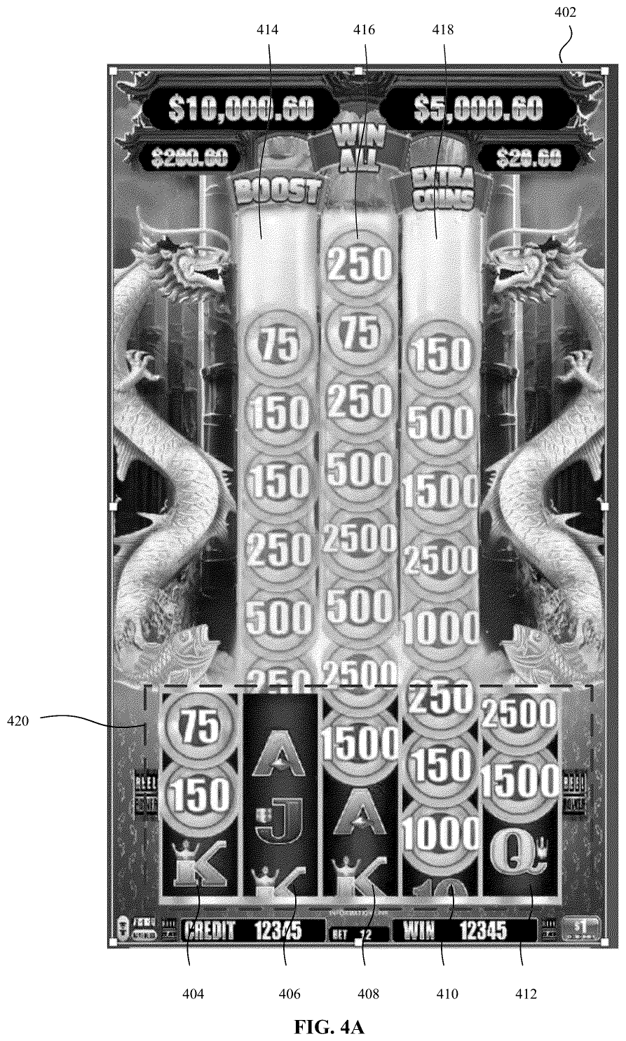

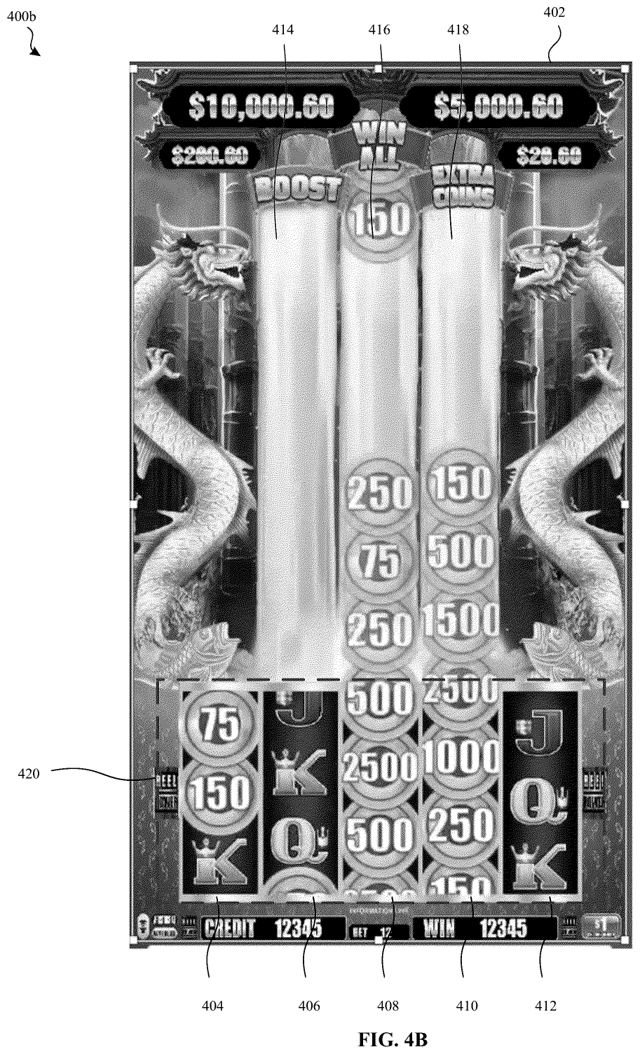

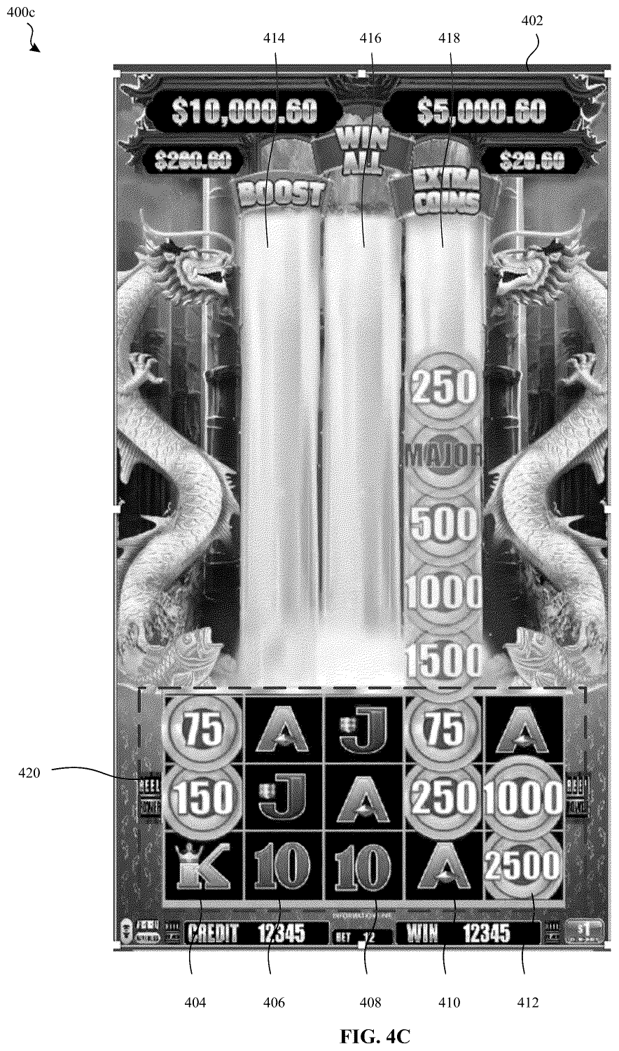

In some embodiments, the UI outcome received by the UI system 302 may be related to triggering of a bonus game or a feature game in which the active game play area during the base game play may be expanded for a bonus game or feature game. Additionally, or alternatively, one or more additional features may be applied during the bonus game or feature game. Various embodiments are described in more detail with respect to FIGS. 4A-4C, and 5-8.

FIGS. 4A-4C illustrate an exemplary screenshot or user interface of an EGM during a base game play. In an exemplary screenshot 400a shown in FIG. 4A, an EGM 402 may have columns 404, 406, 408, 410, and 412, and one or more columns of columns 404, 406, 408, 410, and 412 may display game symbols in a specific number of game symbol positions or a specific number of rows, which forms an active play area during a base game play. The active play area may be as shown by 420 in the exemplary screenshot 400a. The active play area may be displayed in a lower section of a display device of the EGM 402. Each column 404, 406, 408, 410, and 412 may be associated with a respective stack. For example, the column 406 may be associated with a stack 414, the column 408 may be associated with a stack 416, and the column 410 may be associated with a stack 418. The columns 404 and 412 may also be associated with a respective stack (not shown in the screenshot 400a as a numbered stack) which may be hidden or invisible on the display device of the EGM 402 during the base game play. In other words, game symbols shown as falling from the top of columns 404 and 412 may not be displayed until the game symbols on the columns 404 and 412 are in the active play area 420. By way of a non-limiting example, the stacks 414, 416, and 418 associated with columns 406, 408, and 410 may be assigned a respective additional feature. By way of a non-limiting example, the stack 414 may be associated with a boost feature, the stack 416 may be associated with a win-all feature, and the stack 418 may be associated with an extra-coin feature. In certain embodiments, each symbol position may include its own reel for spinning and displaying symbols. In other embodiments, each column and stack may be its own reel for spinning and displaying symbols falling from top to bottom before landing in a stopped position.

As described herein, upon receiving an amount of bet or wager from a player, the columns 404, 406, 408, 410, and 412 may start spinning based on the player's input. While the columns 404, 406, 408, 410, and 412 are spinning, various game symbols on each of the columns 404, 406, 408, 410, and 412 may be displayed as falling from the top of each column. Since stacks associated with columns 404 and 412 are hidden or invisible, no game symbols are visible in the inactive play area in the upper section of the display device of the EGM for the columns 404 and 412. However, game symbols displayed as falling down from the top of the stacks 414, 416, and 418 are visible in the inactive play area in the upper section of the display device of the EGM.

By way of a non-limiting example, only game symbols, which are COR symbols, may be visible in the inactive play area in the upper section of the display device of the EGM, when |the game symbols are displayed as falling down on the columns 406, 408, and 410. A non-COR symbol falling down on the column 406, 408, or 410 may only become visible once the non-COR symbol is in the active play area 420 in the lower section of the display device of the EGM 402. The active play area (or game matrix area) 420 may display three game symbols in each column of columns 404, 406, 408, 410, and 412. In other words, the active play area during the base game may be a 3×5 game matrix area of 3 rows for each of 5 columns.

The game symbols on the columns 404, 406, 408, 410, and 412 as shown in the exemplary screenshot 400a may continue to fall and may be as shown in an exemplary screenshot or user interface 400b of FIG. 4B. While the game symbols on columns 406, 408, and 410 are falling from the top of the columns 406, 408, and 410, a game symbol that is a non-COR symbol may be not identified when the non-COR symbol is in the inactive play area of the columns 406, 408, and/or 410 in the upper section of the display device of the EGM 402. As shown in the exemplary screenshot 400b, the non-COR symbol may only become visible, or may be identified, in the active play area 420.

In the screenshot 400b, non-COR symbols Jack (“J”), King (“K”), and Queen (“Q”) are visible or identified on the column 406, when the non-COR symbols J, K, and Q are in the active play area (or the base game matrix area) 420. However, the non-COR symbols J, K, and Q are invisible, or not identified, in the inactive play area of the column 406 in the upper section of the display device of the EGM 402. Similarly, a gap of game symbols on the columns 408 and 410 in the inactive play area may suggest to the player that there are non-COR symbols falling down on the columns 408 and 410, and these non-COR symbols on the columns 408 and 410 may only become visible, or identified, on the columns 408 and 410 in the base game matrix area 420.

An exemplary screenshot or user interface 400c shown in FIG. 4C may correspond with a view or state of the EGM when spinning of reels on the columns 404, 406, 408, 410, and 412 has stopped. As shown in the screenshot 400c, when the reels on the columns 404, 406, 408, 410, and 412 stopped spinning, if a certain number of designated symbols (e.g., 6 COR symbols) appears on the reels on specific columns in the active play area (or the base game matrix area) 420, a bonus game or feature game may be triggered. In some embodiments, and by way of a non-limiting example, a COR symbol that lands on a reel on a column, for example, the column 404 and/or the column 412, not associated with a stack that is assigned an additional feature, may also contribute to the number of designated symbols (e.g., 6 COR symbols) triggering a bonus game or feature game when at least one designated symbol also lands on a reel on a column that is associated with a stack, which has been assigned an additional feature.

In the screenshot 400c, two COR symbols are shown on the stopped reels of columns 404, 410, and 412 in the active play area 420, which may trigger a bonus game or feature game. When the reels stopped spinning, symbols that are non-COR symbols on the reels in columns 406 and 408 and in the inactive play area may not be displayed in the inactive play area in the upper section of the display device of the EGM 402. However, game symbols that are COR symbols on the reel on the column 410 may be displayed in the inactive play area in the upper section of the display device.

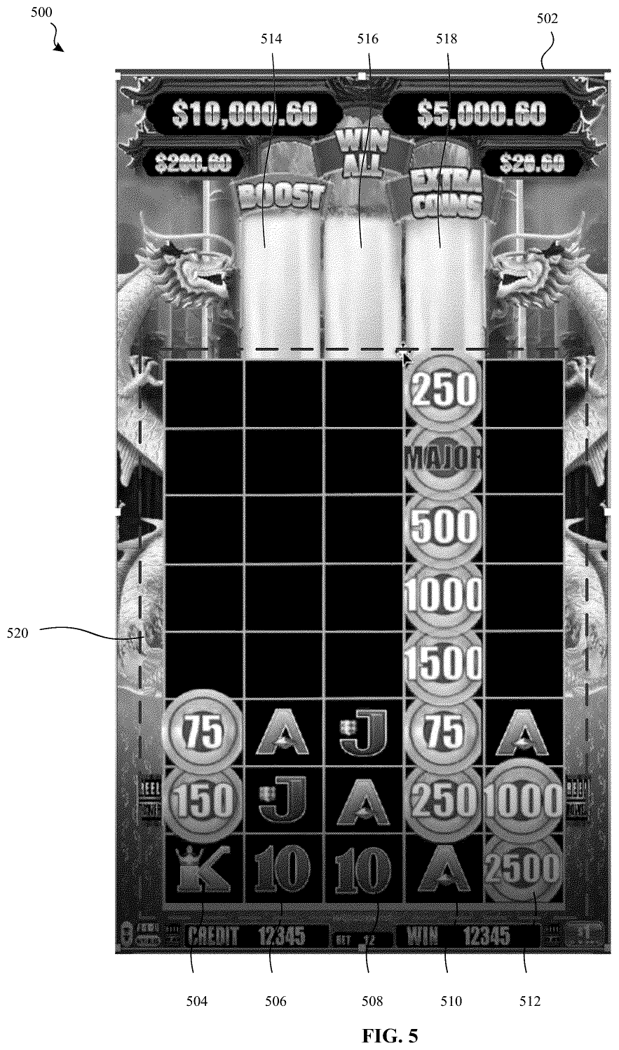

FIG. 5 illustrates an exemplary screenshot or user interface 500 of an EGM 502 when a bonus game or feature game is triggered. As shown in the screenshot 500, when a bonus game or feature game is triggered, the active play area (or base game matrix area) 420 is expanded such that a game matrix area 520 (also referenced herein as a bonus game matrix area 520) includes game symbol positions or rows of columns 504, 506, 508, 510, and 512 which are in the inactive play area during the base game play. The bonus game matrix area 520 may include game symbol positions or rows of the columns 504, 506, 508, 510, and 512 corresponding to the highest row displaying contiguous COR symbols on the column 510 associated with a stack 518, which is assigned an additional feature (e.g., an extra-coin feature). Even though no COR symbol landed on the reels in columns 506 and 508 in the active play area (or the base game matrix area) 420 when the reels stopped during the base game play, the bonus game matrix area 520 may be extended to include rows of columns 506 and 508 up to the highest row displaying contiguous COR symbols on the column 510. However, during the bonus game, additional features associated with stacks corresponding to columns 506 and 508 may not be assigned for the bonus game or feature game, but an additional feature associated with a stack corresponding to the column 510 on which a COR symbol triggering the bonus game landed may be assigned during the bonus game.

During the bonus game, each game symbol position on the columns 504, 506, 508, 510, and 512 may become a reel. The player may be awarded a certain number of spins (e.g., three spins) during the bonus game play, which may be indicated on a, e.g., remaining bonus game spins counter and decremented by one spin with each spin of the bonus game. Each reel corresponding to each game symbol position may spin during a bonus spin. If a COR or another designated symbol (e.g., an addition free spin symbol) appears on a reel corresponding to any game symbol position, the COR symbol or the other designated symbol may remain visible during subsequent spins. Additionally, if a COR symbol or other designated symbol appears on a reel corresponding to any game symbol position, the certain number of spins may be incremented by one or more spins, and/or reset to the initially awarded certain number of spins (e.g., three spins). At the end of the awarded certain number of spins (e.g., three spins) and/or when a number of spins counter, decremented by one spin with each spin of the bonus game, indicates zero spins remain, a total prize to the player may be calculated based on the COR symbols landed in the bonus game matrix area 520.

In some embodiments, and by way of a non-limiting example, a bonus game or feature game may be randomly triggered (using an RNG) when the reels are spun for at least a pre-determined number of minimum times (e.g., 60 spins) and before a pre-determined number of maximum times (e.g., 120 spins). During the bonus game or feature game, an animation showing coins raining, for example, from a mouth of a dragon may be displayed.

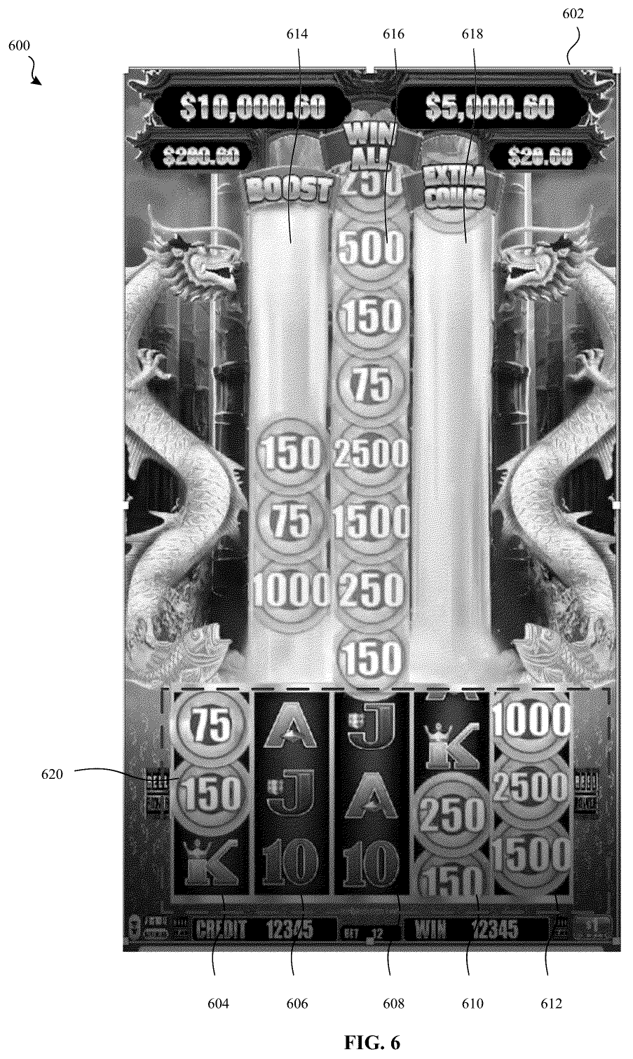

FIG. 6 illustrates an exemplary screenshot or user interface 600 of an EGM 602. As shown in the screenshot 600, even though at least a certain number of designated symbols (e.g., six COR symbols) are shown as landed on reels in columns 604, 606, 608, 610, and 612, no COR symbol landed on the reels in columns 606 and 608 associated with stacks 614 and 616, respectively, in the inactive play area, during the base game play, in the upper section of the display device of the EGM 602. While COR symbols landed on the reel in column 610 associated with a stack 618, no COR symbol landed in the inactive play area, during the base game play, in the upper section of the display device of the EGM 602. Because a column displaying at least one COR symbol in the active play area does not have a COR symbol in the inactive play area contiguous from the boundary of the active play area, a bonus game or feature game may not be triggered, and the base game matrix area 620 may not be expanded.

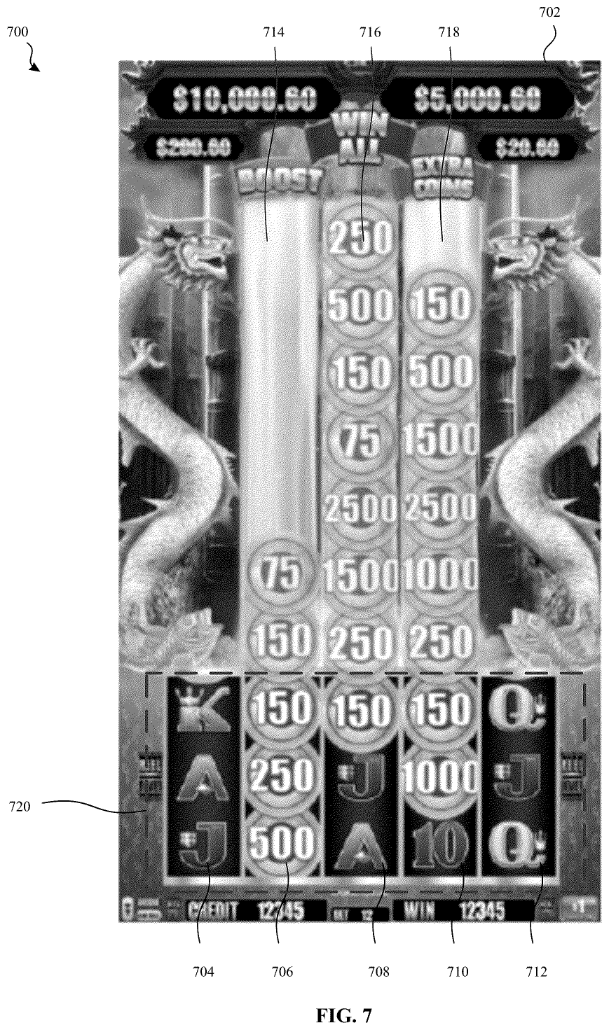

FIG. 7 illustrates an exemplary screenshot or user interface 700 of an EGM 702. As shown in the screenshot 700, when reels in the columns 704, 706, 708, 710, and 712 stopped spinning during the base game play, a certain number of designated symbols (e.g., six COR symbols) landed on the reels in columns 704, 706, 708, 710, and 712 in a base game matrix area 720, and a bonus game may be triggered. In this example shown in the screenshot 700, since the COR symbols landed on the reels in the columns 706, 708, and 710 that are associated with stacks 714, 716, and 718, respectively, and each of the stacks 714, 716, and 718 is assigned a respective additional feature, a bonus game or feature may be triggered. During the bonus game or feature game, additional features associated with each stack of the stacks 714, 716, and 718 may be activated. Contiguous COR symbols are displayed in columns 706, 708, and 710 in the inactive play area extending from the boundary of the active play area 720, and the active play area 720 may be expanded corresponding to the row of a column with the highest stack of contiguous COR symbols, which in this example is column 708, in which the COR symbol is displayed as landed, when the reels in columns 704, 706, 708, 710, and 712 stopped spinning.

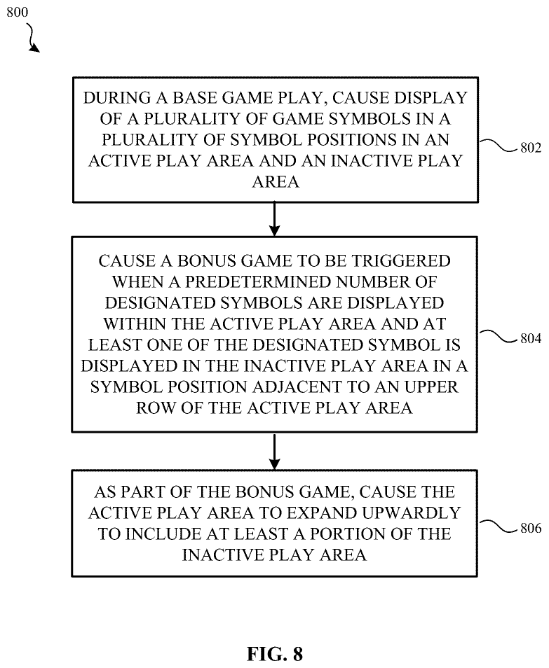

FIG. 8 illustrates an exemplary flow-chart 800 of method operations performed by an EGM, in accordance with some embodiments. The method operations may be performed by an EGM, where each EGM may include a display device, and an interface component coupling the EGM with an electronic gaming server. Each EGM may also include a memory device that is configured to store instructions, which may be executed by a game controller of the EGM. The game controller may include a processor that is configured to execute the instructions stored in the memory device and/or instructions received from the electronic gaming server. One or more instructions received from the electronic gaming server and/or the EGM may be generated using at least one RNG. By way of a non-limiting example, the EGM may be a user equipment such as a smartphone, a tablet, a laptop, a smart glass, and so on.

The EGM may receive an amount of bet wagered by a player on the EGM. The bet wagered by the player on the EGM may be cash, tokens, and/or credits, and so on. The bet may be wagered by the player in other forms as well. In response to the received amount of bet or wager, and in response to the user input to begin a base game play, a plurality of reels of the EGM are spun and a plurality of game symbols are displayed 802 in a plurality of symbol positions in active and inactive play areas of a first subset of columns (of a plurality of columns) and in an active play area of a second subset of columns (of the plurality of columns). The first subset of columns may include columns 406, 408, and/or 410, and the second subset of columns may include columns 404 and/or 412. Each column of the first subset of columns may be associated with a respective stack of a plurality of stacks (e.g., stacks 414, 416, and/or 418) that corresponds with a particular game feature (or game category). As described herein, the particular game feature may be a boost feature, a win-all feature, and/or an extra-coin feature, and so on.

While reels in the first subset of columns are spinning, a plurality of game symbols including one or more trigger symbols (or designated symbols) and/or one or more non trigger symbols (or non-designated symbols) may be displayed in a respective active play area and a respective inactive play area of each column of the first subset of columns. As described herein, the respective active play area of each column of the first subset of columns may be a lower section or a bottom section of the display device. The lower section or the bottom section of the display device may form a game matrix area (e.g., a game matrix area 420) during a base game play. The respective inactive play area of the plurality of columns may be an upper section or a top section of the display device. The trigger symbols may include cash-on reels (COR) symbols. Accordingly, the active play area may include a plurality of rows and columns of symbol positions, and the inactive play area may include a plurality of stacks of symbol positions. Each stack of the plurality of stacks (or each stack of a subset of stacks of the plurality of stacks) may correspond with at least one column of the first subset of columns.

When a plurality of reels are spinning, a plurality of game symbols including one or more designated symbols and/or the one or more non-designated symbols may be displayed in the active play area corresponding to the first subset of columns and the second subset of columns. However, the one or more non-designated symbols may be prevented from displaying in the inactive play area corresponding to the first subset of columns. As described herein, the active play area may be a game matrix area (e.g., a game matrix area 420) during a base game play. By way of a non-limiting example, no game symbol may be displayed in the inactive play area corresponding to the second subset of columns during the base game play.

As the plurality of reels stops spinning, a bonus game may be triggered 804 when a pre-determined number of designated symbols are displayed within the active play area and at least one of the designated symbols is displayed in the inactive play area in a symbol position adjacent to an upper row of the active play area. Additionally, or alternatively, the bonus game may be triggered when at least one designated symbol of the pre-determined number of designated symbols is displayed in at least one column of the first subset of columns in the active play area when the plurality of reels stops spinning. By way of a non-limiting example, the pre-determined number of designated symbols may be six COR symbols or at least six COR symbols. Thus if at least one COR symbol lands on a column of the first subset of columns (e.g., the column 406, 408, or 410) and a total number of COR symbols landing on the plurality of columns (e.g., columns 404, 406, 408, 410, and 412), in the active play area (e.g., the active play area 420) is at least the pre-determined number of COR symbols, the bonus game may be triggered 804. By way of a non-limiting example, the bonus game may be triggered 804 randomly using an RNG after the plurality of reels are spun at least for a first pre-determined number of times (e.g., 60 times) and before a second pre-determined number of times (e.g., 120 times).

In some embodiments, and by way of a non-limiting example, the bonus game may be triggered 804 when at least one designated symbol lands on the at least one column of the first subset of columns in the respective portion of the inactive play area of the at least one column of the first subset of columns when the plurality of reels stopped spinning. For example, as discussed herein with reference to FIG. 6, the bonus game may not be triggered when no COR symbol landed on the at least one column of the first subset of columns (e.g., the column 610) in the respective inactive play area of the first subset of column. However, as discussed herein with reference to FIG. 5 and/or FIG. 7, the bonus game may be triggered when a COR symbol landed on the at least one column of the first subset of columns (e.g., the column 510, the columns 706, 708, and 710) in the respective inactive play area of the first subset of columns.

In some embodiments, the bonus game may be triggered if the pre-determined number of designated symbols lands in a specific pattern on the columns in the respective active play area of the first subset of columns and/or the second subset of columns. The specific pattern may be designated symbols in a single row, or in game symbol positions that are in a diagonal pattern. In other words, the bonus game may be triggered in accordance with principles of a bingo game.

When the bonus game is triggered 804, a game matrix area (e.g., the game matrix area 420) may be expanded 806 to further include at least a part of the respective portion of the inactive play area of each column of the plurality of columns (e.g., the game matrix area 520). By way of a non-limiting example, the part of the respective portion of the inactive play area included in the game matrix area may be determined based on the highest symbol position of a designated symbol, on the at least one column of the first subset of columns, in respective inactive play area of the at least one column of the first subset of columns. For example, as described herein, the game matrix area may be expanded based on the highest position of a COR symbol in the respective inactive play area of the column 510 as shown in FIG. 5. Similarly, the game matrix area may be expanded based on the highest position of a COR symbol in the respective inactive play area of the column 708 as shown in FIG. 7. Since the COR symbol on the column 708 is at a higher position when compared with a COR symbol on the column 710, the game matrix area may be expanded based on the highest position of the COR symbol in the respective inactive play area of the column 708. Accordingly, in other words, the active play area is expanded upwardly up to a height equal to a highest symbol position displaying designated symbols that are contiguous with the upper row of the active play area and/or a designated symbol displayed in the upper row of the active play area.

When the bonus game is triggered 804, one or more game features may be activated. Each of the one or more game features may be associated with a stack of the plurality of stacks associated with a column of the first subset of columns on which the at least one designated symbol landed when the plurality of reels stopped spinning. Additionally, or alternatively, during the bonus game, one or more game symbol positions associated with a column of at least one of the first subset of columns and the second subset of columns may be spun as a respective individual reel for at least a particular number of times (e.g., 3 times or at least 3 times). When the bonus game is triggered 804, no non-COR game symbol may be displayed on the respective individual reel which is spun during the bonus game. During the bonus game, and when the respective individual reel stopped spinning, if a designated symbol (e.g., a COR symbol) lands on a respective individual reel, that respective individual reel may not be spun during the remaining spins of the at least the particular number of times (e.g., 3 times of at least 3 times), and the COR symbols may remain visually displayed in that particular game symbol position.

Accordingly, various embodiments, as described herein, provide significant improvement by increasing the game matrix area and activating one or more different features during the bonus game.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
at least one memory with instructions stored thereon; and
at least one processor in communication with the at least one memory, wherein the instructions, when executed by the at least one processor, cause the at least one processor to:
cause display of a plurality of game symbols in a plurality of symbol positions within an active play area and an inactive play area of a base game, the active play area including a plurality of rows and columns of symbol positions, and the inactive play area including a plurality of stacks of symbol positions, each stack of the plurality of stacks corresponding to at least one column of a first subset of columns of the plurality of columns;
cause a bonus game to be triggered when a predetermined number of designated symbols are displayed within the active play area and at least one of the designated symbols is displayed in the inactive play area in a symbol position adjacent to an upper row of the active play area; and
as part of the bonus game, cause the active play area to expand upwardly to include at least a portion of the inactive play area to a height equal to a highest symbol position displaying contiguous designated symbols.

2. The electronic gaming system of claim 1, wherein at least one designated symbol of the predetermined number of designated symbols is displayed within the active play area in a column of the first subset of columns.

3. The electronic gaming system of claim 1, wherein the instructions, which, when executed, further cause the at least one processor to activate a predefined game feature associated with one of the stacks corresponding to the at least one column of the first subset of columns.

4. The electronic gaming system of claim 1, wherein the instructions, which, when executed, further cause the at least one processor to hide from display any non-designated symbols within the inactive play area.

5. The electronic gaming system of claim 1, wherein the instructions, which, when executed, further cause the at least one processor to:
cause the expanded play area of the bonus game to become an expanded active play area including a plurality of active symbol positions;
convert each symbol position of the plurality of symbol positions within the expanded play area to include a spinnable virtual reel;
cause the symbol positions within the expanded play area displaying one of the designated symbols to not spin; and
cause the other symbol positions within the expanded play area to spin.

6. The electronic gaming system of claim 5, wherein the instructions, which, when executed, further cause the at least one processor to cause the other symbol positions within the expanded play area to spin until a designated symbol is displayed in one or more of the other symbol positions.

7. The electronic gaming system of claim 5, wherein the instructions, which, when executed, further cause the at least one processor to visually display a designated symbol landing within one of the other symbol positions within the expanded play area during the bonus game as part of a hold-and-spin feature.

8. The electronic gaming system of claim 7, wherein the instructions, which, when executed, further cause the at least one processor to continue the hold-and-spin feature until a designated number of free spins have been completed or until all of the symbol positions within the expanded play area display one of the designated symbols.

9. The electronic gaming system of claim 1, wherein each designated symbol is a credit value symbol having a randomly determined credit value associated therewith.

10. A computer-implemented method of electronic gaming implemented by at least one processor in communication with at least one memory, the method comprising:
causing display of a plurality of game symbols in a plurality of symbol positions within an active play area and an inactive play area of a base game, the active play area including a plurality of rows and columns of symbol positions, and the inactive play area including a plurality of stacks of symbol positions, each stack of the plurality of stacks corresponding to at least one column of a first subset of columns of the plurality of columns;
causing a bonus game to be triggered when a predetermined number of designated symbols are displayed within the active play area and at least one of the designated symbols is displayed in the inactive play area in a symbol position adjacent to an upper row of the active play area; and
as part of the bonus game, causing the active play area to expand upwardly to include at least a portion of the inactive play area to a height equal to a highest symbol position displaying contiguous designated symbols.

11. The method of claim 10 further comprising causing at least one designated symbol of the predetermined number of designated symbols to be displayed within the active play area in a column of the first subset of columns.

12. The method of claim 10 further comprising activating a predefined game feature associated with one of the stacks corresponding to the at least one column of the first subset of columns.

13. The method of claim 10 further comprising causing the at least one processor to hide from display any non-designated symbols within the inactive play area.

14. The method of claim 10 further comprising:
causing the expanded play area of the bonus game to become an expanded active play area including a plurality of active symbol positions;
converting each symbol position of the plurality of symbol positions within the expanded play area to include a spinnable virtual reel;
causing the symbol positions within the expanded play area displaying one of the designated symbols to not spin; and
causing the other symbol positions within the expanded play area to spin.

15. The method of claim 14 further comprising causing the other symbol positions within the expanded play area to spin until a designated symbol is displayed in one or more of the other symbol positions.

16. The method of claim 14 further comprising visually displaying a designated symbol landing within one of the other symbol positions within the expanded play area during the bonus game as part of a hold-and-spin feature.

17. The method of claim 16 further comprising causing the hold-and-spin feature to continue until a designated number of free spins have been completed or until all of the symbol positions within the expanded play area display one of the designated symbols.

18. At least one non-transitory computer-readable storage medium with instructions stored thereon that, in response to execution by at least one processor, cause the at least one processor to:
cause display of a plurality of game symbols in a plurality of symbol positions within an active play area and an inactive play area of a base game, the active play area including a plurality of rows and columns of symbol positions, and the inactive play area including a plurality of stacks of symbol positions, each stack of the plurality of stacks corresponding to at least one column of a first subset of columns of the plurality of columns;
cause a bonus game to be triggered when a predetermined number of designated symbols are displayed within the active play area and at least one of the designated symbols is displayed in the inactive play area in a symbol position adjacent to an upper row of the active play area; and
as part of the bonus game, cause the active play area to expand upwardly to include at least a portion of the inactive play area to a height equal to a highest symbol position displaying contiguous designated symbols.

19. The at least one non-transitory computer-readable storage medium of claim 18, wherein the instructions further cause the at least one processor to:
cause the expanded play area of the bonus game to become an expanded active play area including a plurality of active symbol positions;
convert each symbol position of the plurality of symbol positions within the expanded play area to include a spinnable virtual reel;
cause the symbol positions within the expanded play area displaying one of the designated symbols to not spin; and
cause the other symbol positions within the expanded play area to spin.

20. The at least one non-transitory computer-readable storage medium of claim 19, wherein the instructions further cause the at least one processor to cause the other symbol positions within the expanded play area to spin until a designated symbol is displayed in one or more of the other symbol positions.
